(19) United States
(12) Patent Application Publication
(10) Pub. No.: US 2025/0389676 A1
(43) Pub. Date: Dec. 25, 2025

(54) Void Inspection Method, Storage and Void Inspection System

(71) Applicant: SHIMADZU CORPORATION, Kyoto-shi (JP)

(72) Inventor: Kazuki KANAMOTO, Kyoto-shi (JP)

(21) Appl. No.: 19/248,217

(22) Filed: Jun. 24, 2025

(30) Foreign Application Priority Data
Jun. 25, 2024 (JP) 2024-102410

(51) Int. Cl. G01N 23/04; G01N 23/18

(52) U.S. Cl. CPC G01N 23/04; G01N 23/18; G01N 2223/401; G01N 2223/42; G01N 2223/648

(57) ABSTRACT

A void inspection method according to this invention includes generating a void image in which a void area included in the solder ball area is extracted to avoid extraction of an outer peripheral part of the solder ball area as the void area irrespective of pixel values of the outer peripheral part of the solder ball area in the solder ball image.

### CROSS-REFERENCE TO RELATED APPLICATIONS

The related application number JP2024-102410, void inspection method, storage and void inspection system, Jun. 25, 2024, Kazuki Kanamoto, upon which this patent application is based is hereby incorporated by reference.

### BACKGROUND OF THE INVENTION

### Field of the Invention

The present invention relates to a void inspection method, a storage and a void inspection system. Description of the Background Art

X-ray imaging systems generating X-ray images of boards on which solder balls are placed are known in the art. Such an X-ray imaging system is disclosed in Japanese Patent Laid-Open Publication No. JP2024-29975, for example.

Japanese Patent Laid-Open Publication No. JP2024-29975 discloses an X-ray imaging system including a fluoroscopic apparatus generating X-ray images of a board on which solder balls are placed and an analysis apparatus analyzing the X-ray images generated. In the X-ray imaging system described in Japanese Patent Application Publication No. 2024-29975, inspection for a defect such as voids and the like in the solder balls is performed. Electronic components are mounted on the board on which the solder balls are placed as stated in Japanese Patent Application Publication No. 2024-29975.

Here, although not stated in Japanese Patent Application Publication No. 2024-29975, in a case in which voids in solder balls are inspected in known X-ray imaging systems such as the X-ray imaging system described in Japanese Patent Application Publication No. 2024-29975, the luminance in the X-ray image of the board changes not only due to the voids but also due to the placement of the electronic components on the board since the electronic components are mounted on the board on which the solder balls are placed. For this reason, the voids in solder balls will be incorrectly detected.

### SUMMARY OF THE INVENTION

The present invention is intended to solve the above problem, and one object of the present invention is to provide a void inspection method, a storage and a void inspection system capable of reducing incorrect detection of a void in a solder ball.

In order to attain the aforementioned object, a void inspection method according to a first aspect of the present invention includes generating a solder ball image in which a solder ball area is extracted from an X-ray image of a board on which a solder ball is placed; and generating a void image in which a void area included in the solder ball area is extracted to avoid extraction of an outer peripheral part of the solder ball area as the void area irrespective of pixel values of the outer peripheral part of the solder ball area in the solder ball image.

Also, in order to attain the aforementioned object, a storage according to a second aspect of the present invention stores a void inspection program that causes a computer to perform control to generate a solder ball image in which a solder ball area is extracted from an X-ray image of a board on which a solder ball is placed; and control to generate a void image in which a void area included in the solder ball area is extracted to avoid extraction of an outer peripheral part of the solder ball area as the void area irrespective of pixel values of the outer peripheral part of the solder ball area in the solder ball image.

Also, in order to attain the aforementioned object, a void inspection system according to a third aspect of the present invention includes an X-ray imaging apparatus performing X-ray imaging of a board on which a solder ball is placed; and a void inspection apparatus performing control to generate an X-ray image of the board, which is subjected to the X-ray imaging, control to generate a solder ball image in which a solder ball area is extracted from the X-ray image, and control to generate a void image in which a void area included in the solder ball area is extracted to avoid extraction of an outer peripheral part of the solder ball area as the void area irrespective of pixel values of the outer peripheral part of the solder ball area in the solder ball image.

The present inventor has diligently studied void inspection, and as a result has found that voids hardly exist in an outer peripheral part of a solder ball area. From this finding, in the aforementioned void inspection method according to the first aspect, the aforementioned storage according to the second aspect, and the aforementioned void inspection system according to the third aspect, as discussed above, a void image in which a void area included in the solder ball area is extracted is generated to avoid extraction of an outer peripheral part of a solder ball area as the void area irrespective of pixel values of the outer peripheral part of the solder ball area in the solder ball image. Accordingly, when the void area included in the solder ball area is extracted, even if pixel values of the outer peripheral part of the solder ball area satisfy a condition for extraction of the void area, the outer peripheral part of the solder ball area, which is a part, such as an electronic component, highly unlikely to contain the void, is not extracted as the void area. Consequently, it is possible to reduce incorrect detection of the void in the solder ball.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an overall configuration of a void inspection system according to one embodiment of the present invention.

FIG. 2 is a view showing a board on which solder balls are placed according to the one embodiment of the present invention.

FIG. 3 is a view illustrating images generated in the void inspection system according to the one embodiment of the present invention.

FIG. 4 is a view illustrating generation of a void image in which outer-periphery-correspondence part and connection parts in a condition-satisfying area are excluded from an extraction image in the void inspection system according to the one embodiment of the present invention.

FIG. 5 is a chart illustrating a flow of a void inspection method according to the one embodiment of the present invention.

### DESCRIPTION OF THE PREFERRED EMBODIMENT

The following description will describe an embodiment embodying the present invention with reference to the drawings.

### Void Inspection System

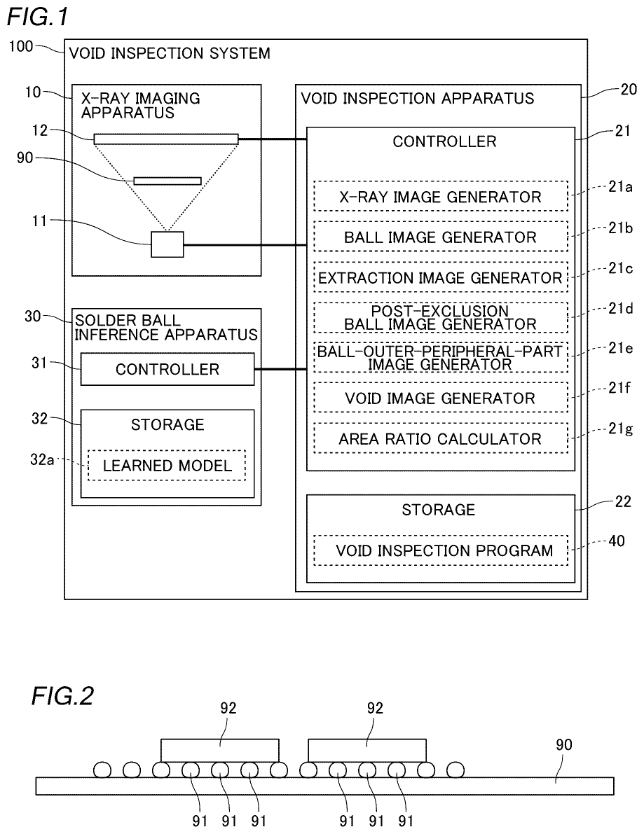

The following description describes a configuration of a void inspection system 100 according to this embodiment with reference to FIGS. 1 to 4.

### (Overall Configuration of Void Inspection System)

As shown in FIG. 1, the void inspection system 100 includes an X-ray imaging apparatus 10, a void inspection apparatus 20, and a solder ball inference apparatus 30. The void inspection system 100 is a system for inspecting voids in a plurality of solder balls 91 (bumps) (see FIG. 2) placed on a board 90. The X-ray imaging apparatus 10 and the solder ball inference apparatus 30 are connected to a controller 21 of the void inspection apparatus 20, which will be described later, to be able to communicate with each other.

As shown in FIG. 2, the plurality of solder balls 91 and electronic components 92 are mounted on the board 90. The electronic component 92 is electrically connected to the board 90 through the plurality of solder balls 91. The plurality of solder balls 91 have approximately the same size as each other. The plurality of solder balls 91 are arranged in a grid arrangement on the board 90. In other words, the electronic components 92 are connected to the board 90 through a BGA (Ball Grid Array). The electronic components 92 are chip capacitors, for example.

### (Configuration of X-Ray Imaging Apparatus)

As shown in FIG. 1, the X-ray imaging apparatus 10 is an apparatus that performs X-ray imaging of the board 90 on which the plurality of solder balls 91 (see FIG. 2) are placed. The X-ray imaging apparatus 10 includes an X-ray irradiator 11 and an X-ray detector 12.

The X-ray irradiator 11 is configured to irradiate the board with X-rays. The X-ray irradiator 11 includes an X-ray tube configured to irradiate the board with X-rays when electric power is supplied from a power supply (not shown). The X-ray irradiator 11 irradiates the board 90 on which the plurality of solder balls 91 (see FIG. 2) are placed with X-rays.

The X-ray detector 12 detects X-rays with which the board is irradiated by the X-ray irradiator 11. The X-ray detector 12 outputs electrical signals corresponding to X-rays detected. The X-ray detector 12 is an FPD (Flat Panel Detector), for example. The electrical signals output from the X-ray detector 12 are input to the controller 21, which will be described later, of the void inspection apparatus 20.

### (Configuration of Void Inspection Apparatus)

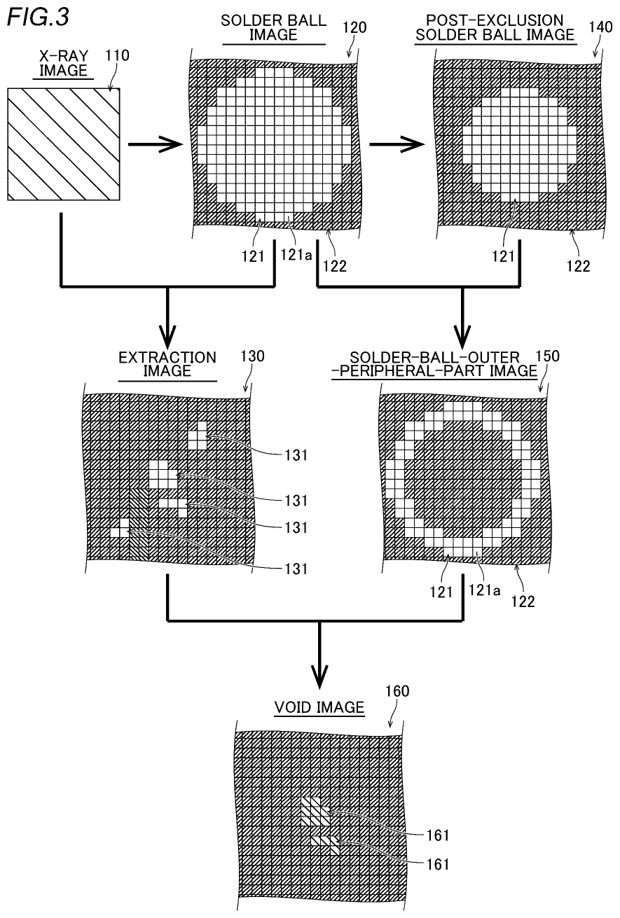

As shown in FIG. 1, the void inspection apparatus 20 is an apparatus that inspects voids in the solder balls 91 (see FIG. 2) placed on the board 90 by using an X-ray image 110 (see FIG. 3), which is captured by X-ray imaging by using the X-ray imaging apparatus 10, of the board 90 on which the plurality of solder balls 91 are placed. The void inspection apparatus 20 includes a controller 21 and a storage 22.

The controller 21 controls X-ray irradiation by the X-ray irradiator 11 by controlling the power supply (not shown). The controller 21 includes a processor, such as a CPU (Central Processing Unit), a GPU (Graphics Processing Unit) and an FPGA (Field-Programmable Gate Array) configured for image processing, and a memory, such as a ROM (Read Only Memory) and a RAM (Random Access Memory), for example.

The storage 22 stores various programs to be executed by the controller 21, various parameters, and the like. The storage 22 includes a nonvolatile memory, such as an HDD (Hard Disk Drive) and an SSD (Solid State Drive), for example. The storage 22 stores a void inspection program 40, which will be described later.

### (Configuration of Solder Ball Inference Apparatus)

As shown in FIG. 1, the solder ball inference apparatus 30 is an apparatus that infers a part in the X-ray image 110 that is a solder ball area 121 (see FIG. 3). The solder ball inference apparatus 30 includes a controller 31 and a storage 32.

The controller 31 includes a processor, such as a CPU, GPU and FPGA, configured for image processing, and a memory such as ROM and RAM, for example. The controller 31 performs control to generate a probability image (inference image) representing a probability of the part that is the solder ball area 121 (see FIG. 3) in the X-ray image 110 (see FIG. 3), which is input from the controller 21 of the void inspection apparatus 20, by using a learned model 32a, which will be described later, stored in the storage 32.

The storage 32 stores various programs to be executed by the controller 31, various parameters, and the like. The storage 32 includes a nonvolatile memory such as an HDD and an SSD, for example. The storage 32 stores the learned model 32a, which previously learned parts in X-ray images 110 (see FIG. 3) that are solder ball areas 121 (see FIG. 3) based on machine learning using a large number of data sets of X-ray images 110.

### (Configuration of Controller of Void Inspection Apparatus for Inspecting Voids in Solder Balls)

As shown in FIG. 1, the controller 21 includes an X-ray image generator 21a, a ball image generator 21b, an extraction image generator 21c, a post-exclusion ball image generator 21d, a ball-outer-peripheral-part image generator 21e, a void image generator 21f, and an area ratio calculator 21g as functional blocks. The X-ray image generator 21a, the ball image generator 21b, the extraction image generator 21c, the post-exclusion ball image generator 21d, the ball-outer-peripheral-part image generator 21e, the void image generator 21f, and the area ratio calculator 21g are constructed of the functional blocks as software realized by executing the void inspection program 40 stored in the storage 22 by the controller 21. In other words, the void inspection program 40 causes a computer (controller 21) to perform control executed by the X-ray image generator 21a, the ball image generator 21b, the extraction image generator 21c, the post-exclusion ball image generator 21d, the ball-outer-peripheral-part image generator 21e, the void image generator 21f, and the area ratio calculator 21g.

### <X-Ray Image Generator>

As shown in FIG. 3, the X-ray image generator 21a (see FIG. 1) performs control to generate the X-ray image 110 of the board 90 (see FIG. 1), which is captured by X-ray imaging. Specifically, as shown in FIG. 1, the X-ray image generator 21a generates the X-ray image 110 (see FIG. 3) based on electrical signals output from the X-ray detector 12 of the X-ray imaging apparatus 10.

### <Ball Image Generator>

As shown in FIG. 3, the ball image generator 21b (see FIG. 1) performs control to generate a solder ball image 120 in which the solder ball area 121 is extracted from the X-ray image 110. Specifically, as shown in FIG. 1, the ball image generator 21b performs control to input the X-ray image 110 (see FIG. 3) to the controller 31 of the solder ball inference apparatus 30. The controller 31 of the solder ball inference apparatus 30 performs control to generate the probability image (inference image) representing the probability of the part that is the solder ball area 121 (see FIG. 3) in the X-ray image 110, which is input from the controller 21 of the void inspection apparatus 20, by using a learned model 32a stored in the storage 32 of the solder ball inference apparatus 30. The controller 31 of the solder ball inference apparatus 30 outputs the generated probability image to the controller 21 of the void inspection apparatus 20. The ball image generator 21b performs control to binarize the probability image (inference image) output from the controller 31 of the solder ball inference apparatus 30 to generate the solder ball image 120 (see FIG. 3). Here, images other than the X-ray image 110 in FIG. 3 are shown as partially enlarged views of the solder ball area 121. Also, in FIG. 3, a ratio of a pixel size to the solder ball area 121 is shown to be larger than its actual ratio for the sake of illustration.

### <Extraction Image Generator>

As shown in FIG. 3, the extraction image generator 21c (see FIG. 1) performs control to generate an extraction image 130 in which a condition-satisfying area 131 is extracted, and the condition-satisfying area is a part whose pixel values in a composite image of the X-ray image 110 and the solder ball image 120 satisfy a condition for extraction of a void area 161. Specifically, the extraction image generator 21c performs control to generate the composite image by adding the pixel values in the X-ray image 110 and the pixel values in the solder ball image 120. Subsequently, the extraction image generator 21c performs control to binarize this composite image based on the conditions for extraction of the void area 161 to extract the condition-satisfying area 131. The conditions (pixel values) for extraction of the void area 161 are previously stored in the storage 22.

### <Post-Exclusion Ball Image Generator>

As shown in FIG. 3, the post-exclusion ball image generator 21d (see FIG. 1) performs control to generate a post-exclusion solder ball image 140 in which the outer peripheral part 121a of the solder ball area 121 in the solder ball image 120 is excluded. Specifically, the post-exclusion ball image generator 21d performs control to generate the post-exclusion solder ball image 140 in which the outer peripheral part 121a of the solder ball area 121 in the solder ball image 120 is excluded by performing contraction processes that contract the solder ball area 121 by changing, into a non-solder-ball area 122, a target pixel in the outer peripheral part 121a of the solder ball area 121 in the solder ball image 120 if four neighboring pixels that are four pixels adjacent to the target pixel on upward, downward, rightward and leftward sides include at least one pixel in the non-solder-ball area 122. Also, the post-exclusion ball image generator 21d performs control to generate the post-exclusion solder ball image 140 in which the outer peripheral part 121a of the solder ball area 121 in the solder ball image 120 is excluded by performing a number of the contraction processes, which corresponds to the Manhattan distance, and the Manhattan distance is previously set to a value not greater than 3% of a diameter of the solder ball area 121. Here, the Manhattan distance is a distance between two points in two-dimensional coordinates that is measured by a sum of absolute differences between the respective coordinates of the two points.

### <Ball-Outer-Peripheral-Part Image Generator>

As shown in FIG. 3, the ball-outer-peripheral-part image generator 21e (see FIG. 1) performs control to generate a solder-ball-outer-peripheral-part image 150 in which only the outer peripheral part 121a of the solder ball area 121 in the solder ball image 120 is extracted. Specifically, the ball-outer-peripheral-part image generator 21e performs control to generate the solder-ball-outer-peripheral-part image 150 by taking difference between the solder ball image 120 and the post-exclusion solder ball image 140.

### <Void Image Generator>

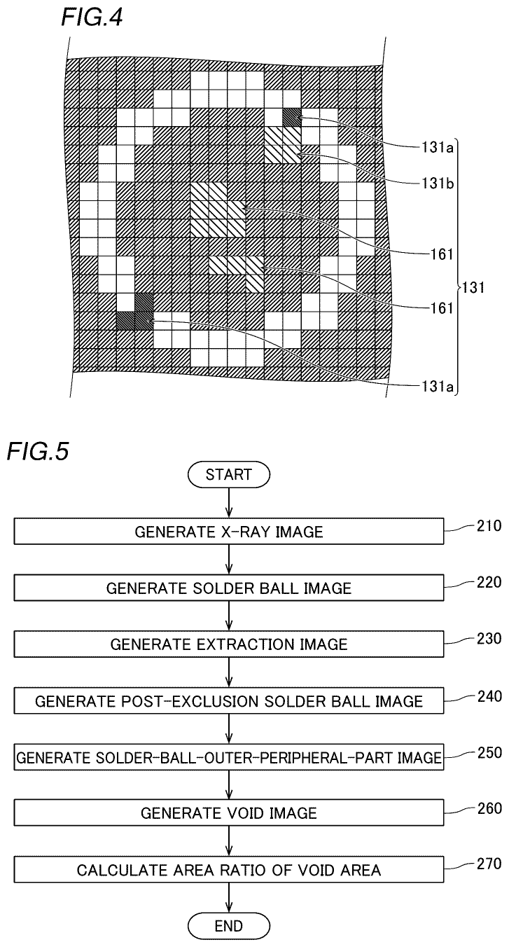

As shown in FIG. 3, the void image generator 21f (see FIG. 1) performs control to generate the void image 160 based on the solder ball image 120 and the extraction image 130 to exclude, from the extraction image 130, an outer-periphery-correspondence part 131a (see FIG. 4) corresponding to the outer peripheral part 121a of the solder ball area 121 in the condition-satisfying area 131. Specifically, the void image generator 21f performs control to generate the void image 160 based on the solder-ball-outer-peripheral-part image 150 and the extraction image 130 to exclude, from the extraction image 130, the outer-periphery-correspondence part 131a of the solder ball area 121 in the condition-satisfying area 131. In other words, the void image generator 21f performs control to generate the void image 160 in which the void area 161 included in the solder ball area 121 is extracted to avoid extraction of the outer peripheral part 121a of the solder ball area 121 as the void area 161 irrespective of pixel values of the outer peripheral part of the solder ball area in the solder ball image 120.

As shown in FIG. 4, the void image generator 21f (see FIG. 1) performs control to generate the void image 160 (see FIG. 3) to exclude, from the extraction image 130 (see FIG. 3), a connection part 131b connected to the outer-periphery-correspondence part 131a in addition to the outer-periphery-correspondence part 131a in the condition-satisfying area 131. Specifically, the void image generator 21f performs control to generate the void image 160 to exclude, from the extraction image 130, a target pixel also as the connection part 131b in addition to the outer-periphery-correspondence part 131a in the condition-satisfying area 131 if eight neighboring pixels that are eight pixels adjacent to the target pixel include at least one pixel connecting the target pixel to the outer-periphery-correspondence part 131a.

### <Area Ratio Calculator>

As shown in FIG. 1, the area ratio calculator 21g performs control to calculate an area ratio of the void area 161 (see FIG. 3) to an area of solder ball area 121 (see FIG. 3) based on the solder ball image 120 (see FIG. 3) and the void image 160 (see FIG. 3). Specifically, the area ratio calculator 21g performs control to calculate ratios of areas of all void areas 161 in the void image 160 to a total area of the plurality of solder balls 91 in the solder ball image 120.

### Void Inspection Method The following description describes a void inspection method according to this embodiment with reference to FIGS. 1 to 5.

### (Step of Generating X-Ray Image)

As shown in FIG. 5, step 210 of generating the X-ray image 110 is first performed. In step 210, the X-ray image 110 shown in FIG. 3, which is captured by X-ray imaging using the X-ray imaging apparatus 10 (see FIG. 1), of the board 90 (see FIG. 2) on which the solder balls 91 (see FIG. 2) are placed is generated. Step 210 is performed by the X-ray image generator 21a (see FIG. 1) of the controller 21 (see FIG. 1) of the void inspection apparatus 20 (see FIG. 1).

### (Step of Generating Solder Ball Image)

Subsequently, as shown in FIG. 5, step 220 of generating the solder ball image 120 is performed. In step 220, as shown in FIG. 3, the solder ball image 120 of the board 90 (see FIG. 2) on which the solder balls 91 (see FIG. 2) are placed is generated by extracting the solder ball area 121 from the X-ray image 110. Step 220 is performed by the ball image generator 21b (see FIG. 1) of the controller 21 (see FIG. 1) of the void inspection apparatus 20 (see FIG. 1).

### (Step of Generating Extraction Image)

Subsequently, as shown in FIG. 5, step 230 of generating the extraction image 130 is performed. In step 230, as shown in FIG. 3, the extraction image 130 in which the condition-satisfying area 131 is extracted, and the condition-satisfying area is a part whose pixel values in a composite image of the X-ray image 110 and the solder ball image 120 satisfy a condition for extraction of the void area 161. Step 230 is performed by the extraction image generator 21c (see FIG. 1) of the controller 21 (see FIG. 1) of the void inspection apparatus 20 (see FIG. 1).

### (Step of Generating Post-Exclusion Solder Ball Image)

Subsequently, as shown in FIG. 5, step 240 of generating the post-exclusion solder ball image 140 is performed. In step 240, as shown in FIG. 3, the post-exclusion solder ball image 140 in which the outer peripheral part 121a of the solder ball area 121 in the solder ball image 120 is excluded is generated. Specifically, in step 240, the post-exclusion solder ball image 140 in which the outer peripheral part 121a of the solder ball area 121 in the solder ball image 120 is excluded is generated by performing contraction processes that contract the solder ball area 121 by changing, into the non-solder-ball area 122, a target pixel in the outer peripheral part 121a of the solder ball area 121 in the solder ball image 120 if four neighboring pixels that are four pixels adjacent to the target pixel on the upward, downward, rightward and leftward sides include at least one pixel in the non-solder-ball area 122. In other words, the contraction processes that contract the solder ball area 121 are performed to change, into the non-solder-ball area 122, a pixel (outermost peripheral pixel) in the solder ball area 121 in the solder ball image 120 that is adjacent to any pixel of the non-solder-ball area 122 that is positioned on the upward, downward, rightward or leftward side of the outermost peripheral pixel. Also, in step 240, the post-exclusion solder ball image 140 in which the outer peripheral part 121a of the solder ball area 121 in the solder ball image 120 is excluded is generated by performing a number of the contraction processes, which corresponds to the Manhattan distance, and the Manhattan distance is previously set to a value not greater than 3% of a diameter of the solder ball area 121. Step 240 is performed by the post-exclusion ball image generator 21d (see FIG. 1) of the controller 21 (see FIG. 1) of the void inspection apparatus 20 (see FIG. 1).

### (Step of Generating Solder-Ball-Outer-Peripheral-Part Image)

Subsequently, as shown in FIG. 5, step 250 of generating the solder-ball-outer-peripheral-part image 150 is performed. In step 250, as shown in FIG. 3, the solder-ball-outer-peripheral-part image 150 in which only the outer peripheral part 121a of the solder ball area 121 in the solder ball image 120 is extracted is generated. Specifically, in step 250, the solder-ball-outer-peripheral-part image 150 is generated by taking difference between the solder ball image 120 and the post-exclusion solder ball image 140. Step 250 is performed by the ball-outer-peripheral-part image generator 21e (see FIG. 1) of the controller 21 (see FIG. 1) of the void inspection apparatus 20 (see FIG. 1).

### (Step of Generating Void Image)

Subsequently, as shown in FIG. 5, step 260 of generating the void image 160 is performed. In step 260, as shown in FIG. 3, the void image 160 is generated based on the solder ball image 120 and the extraction image 130 to exclude, from the extraction image 130, the outer-periphery-correspondence part 131a (see FIG. 4) corresponding to the outer peripheral part 121a of the solder ball area 121 in the condition-satisfying area 131. Specifically, in step 260, the void image 160 is generated based on the solder-ball-outer-peripheral-part image 150 and the extraction image 130 to exclude, from the extraction image 130, the outer-periphery-correspondence part 131a of the solder ball area 121 in the condition-satisfying area 131. In other words, in step 260, the void image 160 in which the void area 161 included in the solder ball area 121 is extracted is generated to avoid extraction of the outer peripheral part 121a of the solder ball area 121 as the void area 161 irrespective of pixel values of the outer peripheral part of the solder ball area in the solder ball image 120. Step 260 is performed by the void image generator 21f (see FIG. 1) of the controller 21 (see FIG. 1) of the void inspection apparatus 20 (see FIG. 1).

In step 260, as shown in FIG. 4, the void image 160 (see FIG. 3) is generated to exclude, from the extraction image 130 (see FIG. 3), the connection part 131b connected to the outer-periphery-correspondence part 131a in addition to the outer-periphery-correspondence part 131a in the condition-satisfying area 131. Specifically, in step 260, the void image 160 is generated to exclude, from the extraction image 130, a target pixel also as the connection part 131b in addition to the outer-periphery-correspondence part 131a in the condition-satisfying area 131 if eight neighboring pixels that are eight pixels adjacent to the target pixel include at least one pixel connecting the target pixel to the outer-periphery-correspondence part 131a. Here, the connection part 131b connected to the outer-periphery-correspondence part 131a in the condition-satisfying area 131 includes, in addition to pixels that are positioned directly adjacent to the outer-periphery-correspondence part 131a in the condition-satisfying area 131, pixels that are positioned indirectly adjacent to the outer-periphery-correspondence part 131a in the condition-satisfying area 131 through the pixels that are positioned directly adjacent to the outer-periphery-correspondence part in the condition-satisfying area.

### (Step of Calculating Area Ratio of Void Area)

Subsequently, as shown in FIG. 5, step 270 of calculating an area ratio of the void area 161. In step 270, the area ratio of the void area 161 (see FIG. 3) to an area of solder ball area 121 (see FIG. 3) is calculated based on the solder ball image 120 (see FIG. 3) and the void image 160 (see FIG. 3). Step 270 is performed by the area ratio calculator 21g (see FIG. 1) of the controller 21 (see FIG. 1) of the void inspection apparatus 20 (see FIG. 1).

### (Advantages of the Embodiment)

In this embodiment, the following advantages are obtained.

### (Advantages of Void Inspection Method)

As described above, the void inspection method according to this embodiment includes step 220 of generating a solder ball image 120 in which solder ball areas 121 are extracted from an X-ray image 110 of a board 90 on which solder balls 91 are placed; and step 260 of generating a void image 160 in which a void area 161 included in the solder ball area 121 is extracted to avoid extraction of an outer peripheral part 121a of the solder ball area 121 as the void area 161 irrespective of pixel values of the outer peripheral part of the solder ball area in the solder ball image 120. Accordingly, when the void area 161 included in the solder ball area 121 is extracted, even if pixel values of the outer peripheral part 121a of the solder ball area 121 satisfy a condition for extraction of the void area 161, the outer peripheral part 121a of the solder ball area 121, which is a part, such as an electronic component, highly unlikely to contain the void, is not extracted as the void area 161. Consequently, it is possible to reduce incorrect detection of voids in the solder ball 91.

In addition, additional advantages can be obtained by the void inspection method according to this embodiment added with configurations discussed below.

That is, as described above, the void inspection method according to this embodiment further includes step 230 of generating an extraction image 130 in which a condition-satisfying area 131 is extracted, and the condition-satisfying area is a part whose pixel values in a composite image of the X-ray image 110 and the solder ball image 120 satisfy a condition for extraction of the void area 161. In addition, the void image 160 is generated based on the solder ball image 120 and the extraction image 130 to exclude, from the extraction image 130, an outer-periphery-correspondence part 131a corresponding to the outer peripheral part 121a of the solder ball area 121 in the condition-satisfying area 131 in step 260 of generating the void image 160. Accordingly, it is possible to generate the void image 160 in which the outer-periphery-correspondence part 131a, which is a part, such as an electronic component, highly unlikely to contain the void, is excluded from the extraction image 130. Consequently, it is possible to achieve a configuration in which, when the void area 161 included in the solder ball area 121 is extracted, even if pixel values of the outer peripheral part 121a of the solder ball area 121 satisfy the condition for extraction of the void area 161, the outer peripheral part 121a of the solder ball area 121, which is a part, such as an electronic component, highly unlikely to contain the void, is not extracted as the void area 161.

Also, as described above, the void inspection method according to this embodiment includes step 250 of generating a solder-ball-outer-peripheral-part image 150 in which only the outer peripheral part 121a of the solder ball area 121 in the solder ball image 120 is extracted. In addition, the void image 160 is generated based on the solder-ball-outer-peripheral-part image 150 and the extraction image 130 to exclude, from the extraction image 130, the outer-periphery-correspondence part 131a of the solder ball area 121 in the condition-satisfying area 131 in step 260 of generating the void image 160. Accordingly, it is possible to easily exclude the outer-periphery-correspondence part 131a corresponding to the outer peripheral part 121a of the solder ball area 121 in the condition-satisfying area 131 from the extraction image 130 based on the solder-ball-outer-peripheral-part image 150 in which only the outer peripheral part 121a of the solder ball area 121 in the solder ball image 120 is extracted, and the extraction image 130.

Also, as described above, the void inspection method according to this embodiment includes step 240 of generating a post-exclusion solder ball image 140 in which the outer peripheral part 121a of the solder ball area 121 in the solder ball image 120 is excluded. In addition, the solder-ball-outer-peripheral-part image 150 is generated by taking difference between the solder ball image 120 and the post-exclusion solder ball image 140 in step 250 of generating the solder-ball-outer-peripheral-part image 150. Accordingly, it is possible to easily generate the solder-ball-outer-peripheral-part image 150 by taking difference between the solder ball image 120 and the post-exclusion solder ball image 140 in which the outer peripheral part 121a of the solder ball area 121 in the solder ball image 120 is excluded.

Also, as described above, in the void inspection method according to this embodiment, the post-exclusion solder ball image 140 in which the outer peripheral part 121a of the solder ball area 121 in the solder ball image 120 is excluded is generated by performing contraction processes that contract the solder ball area 121 by changing, into the non-solder-ball area 122, a target pixel in the outer peripheral part 121a of the solder ball area 121 in the solder ball image 120 if four neighboring pixels that are four pixels adjacent to the target pixel on the upward, downward, rightward and leftward sides include at least one pixel in the non-solder-ball area 122 in step 240 of generating the post-exclusion solder ball image 140. Accordingly, it is possible to prevent a shape of the solder ball area 121 from changing from a round shape into a shape other than the round shape when performing the contraction processes that contract the solder ball area 121 by changing, into the non-solder-ball area 122, a target pixel in the outer peripheral part 121a of the solder ball area 121 in the solder ball image 120 if four neighboring pixels that are four pixels adjacent to the target pixel on the upward, downward, rightward and leftward sides include at least one pixel in the non-solder-ball area 122 to contract the solder ball area 121. In other words, it is possible to prevent the round shape of the solder ball area 121 in the post-exclusion solder ball image 140 from changing into a shape be different from the round shape of the solder ball area 121 in the solder ball image 120. As a result, the post-exclusion solder ball image 140 can be generated to entirely exclude the outer peripheral part 121a in the solder ball area 121 in the solder ball image 120 while maintaining good balance by taking difference between the solder ball image 120 and the post-exclusion solder ball image 140. Here, in a case in which the contraction processes that contract the solder ball area 121 are performed to change a target pixel in the outer peripheral part 121a of the solder ball area 121 in the solder ball image 120 if eight neighboring pixels that are eight pixels adjacent to the target pixel include at least one pixel in the non-solder-ball area 122 into the non-solder-ball area 122, when the solder ball area 121 is contracted, the shape of the solder ball area 121 is likely to change from a round shape into a shape other than the round shape due to also changing a target pixel into the non-solder-ball area 122 if four pixels positioned diagonally adjacent to the target pixel include at least one pixel in the non-solder-ball area 122.

Also, as described above, in the void inspection method according to this embodiment, the post-exclusion solder ball image 140 in which the outer peripheral part 121a of the solder ball area 121 in the solder ball image 120 is excluded is generated by performing a number of the contraction processes in step 240 of generating the post-exclusion solder ball image 140, and the number of the contraction processes corresponds to a preset Manhattan distance. Here, the Manhattan distance is a distance between two points in two-dimensional coordinates that is measured by a sum of absolute differences between the respective coordinates of the two points. For this reason, the Manhattan distance can be easily used in a case in which distances between two points are equal to each other, such as in a case of distances between a target pixel and four neighboring pixels, which are four pixels adjacent to the target pixel on the upward, downward, rightward and leftward sides. Accordingly, the contraction processes that contract the solder ball area 121 to change, into the non-solder-ball area 122, a target pixel in the outer peripheral part 121a of the solder ball area 121 in the solder ball image 120 if four neighboring pixels that are four pixels adjacent to the target pixel on the upward, downward, rightward and leftward sides include at least one pixel in the non-solder-ball area 122 can be easily performed by performing the number of the contraction processes corresponding to the preset Manhattan distance as the contraction processes that contract the solder ball area 121.

Also, as described above, in the void inspection method according to this embodiment, the post-exclusion solder ball image 140 in which the outer peripheral part 121a of the solder ball area 121 in the solder ball image 120 is excluded is generated by performing the number of the contraction processes, which corresponds to the Manhattan distance, in step 240 of generating the post-exclusion solder ball image 140, and the Manhattan distance is set to a value not greater than 3% of a diameter of the solder ball area 121. Accordingly, since the number of the contraction processes that contract the solder ball area 121 does not become too great, it is possible to prevent too many generations of the post-exclusion solder ball image 140 in which the outer peripheral part 121a of the solder ball area 121 in the solder ball image 120 is excluded.

Also, as described above, in the void inspection method according to this embodiment, the void image 160 is generated to exclude, from the extraction image 130, a connection part 131b connected to the outer-periphery-correspondence part 131a in addition to the outer-periphery-correspondence part 131a in the condition-satisfying area 131 in step 260 of generating the void image 160. Accordingly, it is possible to generate the void image 160 in which the connection part 131b connected to the outer-periphery-correspondence part 131a, which is a part, such as an electronic component, highly unlikely to contain the void similar to the outer-periphery-correspondence part 131a, is also excluded in addition to the outer-periphery-correspondence part 131a from the extraction image 130. It is possible to further reduce incorrect detection of voids in the solder ball 91 as compared with a case in which the void image 160 is generated by excluding only the outer-periphery-correspondence part 131a in the condition-satisfying area 131 from the extraction image 130. Also, since the connection part 131b is excluded in addition to the outer-periphery-correspondence part 131a from the extraction image 130, even if the size of the outer-periphery-correspondence part 131a is set to a relatively small size, the void image 160 can be generated to sufficiently exclude, from the extraction image 130, parts highly unlikely to contain voids. For this reason, the size of the outer-periphery-correspondence part 131a can be set to a relatively small size. Consequently, it is possible to prevent exclusion of parts highly likely to contain voids from the extraction image 130 but also to exclude only the parts highly unlikely to contain voids when generating the void image 160.

Also, as described above, in the void inspection method according to this embodiment, the void image 160 is generated to exclude, from the extraction image 130, a target pixel also as the connection part 131b in addition to the outer-periphery-correspondence part 131a in the condition-satisfying area 131 if eight neighboring pixels that are eight pixels adjacent to the target pixel include at least one pixel connecting the target pixel to the outer-periphery-correspondence part 131a in step 260 of generating the void image 160. Accordingly, as compared with a case in which the connection part 131b is set to a part that is connected to the outer-periphery-correspondence part 131a by connecting the target pixel to at least one of four neighboring pixels that are four pixels adjacent to the target pixel on the upward, downward, rightward and leftward sides, it possible to increase the size of the connection part 131b connected to the outer-periphery-correspondence part 131a. For this reason, as compared with a case in which the connection part 131b is set to a part that is connected to the outer-periphery-correspondence part 131a by connecting the target pixel to at least one of four neighboring pixels that are four pixels adjacent to the target pixel on the upward, downward, rightward and leftward sides, it possible to reduce the size of the outer-periphery-correspondence part 131a. Consequently, it is possible to further prevent exclusion of parts highly likely to contain voids from the extraction image 130 but to exclude only the parts highly unlikely to contain voids when generating the void image 160.

### (Advantages of Storage)

As described above, a storage 22 according to this embodiment stores a void inspection program 40 that causes a computer to perform control to generate a solder ball image 120 in which solder ball areas 121 are extracted from an X-ray image 110 of a board 90 on which solder balls 91 are placed; and control to generate the void image 160 in which the void area 161 included in the solder ball area 121 is extracted to avoid extraction of the outer peripheral part 121a of the solder ball area 121 as the void area 161 irrespective of pixel values of the outer peripheral part of the solder ball area in the solder ball image 120. Accordingly, similar to the aforementioned void inspection method, when the void area 161 included in the solder ball area 121 is extracted, even if pixel values of the outer peripheral part 121a of the solder ball area 121 satisfy a condition for extraction of the void area 161, the outer peripheral part 121a of the solder ball area 121, which is a part, such as an electronic component, highly unlikely to contain the void, is not extracted as the void area 161. Consequently, similar to the aforementioned void inspection method, it is possible to reduce incorrect detection of voids in the solder ball 91.

### (Advantages of Void Inspection System)

As described above, the void inspection system 100 according to this embodiment includes an X-ray imaging apparatus 10 performing X-ray imaging of a board 90 on which solder balls 91 is placed; and a void inspection apparatus 20 performing control to generate an X-ray image 110 of the board 90, which is subjected to the X-ray imaging, control to generate a solder ball image 120 in which a solder ball area 121 is extracted from the X-ray image 110, and control to generate a void image 160 in which a void area 161 included in the solder ball area 121 is extracted to avoid extraction of an outer peripheral part 121a of the solder ball area 121 as the void area 161 irrespective of pixel values of the outer peripheral part of the solder ball area in the solder ball image 120. Accordingly, similar to the aforementioned void inspection method and the aforementioned void inspection system, when the void area 161 included in the solder ball area 121 is extracted, even if pixel values of the outer peripheral part 121a of the solder ball area 121 satisfy the condition for extraction of the void area 161, the outer peripheral part 121a of the solder ball area 121, which is a part, such as an electronic component, highly unlikely to contain the void, is not extracted as the void area 161. Consequently, similar to the aforementioned storage and the aforementioned void inspection system, it is possible to reduce incorrect detection of voids in the solder ball 91.

### Modified Embodiments

Note that the embodiment disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

For example, while the example in which the solder-ball-outer-peripheral-part image 150 in which only the outer peripheral part 121a of the solder ball area 121 in the solder ball image 120 is extracted is generated, and the void image 160 is generated based on the solder-ball-outer-peripheral-part image 150 and the extraction image 130 to exclude, from the extraction image 130, the outer-periphery-correspondence part 131a of the solder ball area 121 in the condition-satisfying area 131 has been shown in the aforementioned embodiment, the present invention is not limited to this. In the present invention, the void image may be generated based on an image other than the solder-ball-outer-peripheral-part image and the extraction image to exclude, from the extraction image, the outer-periphery-correspondence part of the solder ball area in the condition-satisfying area.

Also, while the example in which the post-exclusion solder ball image 140 in which the outer peripheral part 121a of the solder ball area 121 in the solder ball image 120 is excluded is generated, and the solder-ball-outer-peripheral-part image 150 is generated by taking difference between the solder ball image 120 and the post-exclusion solder ball image 140 has been shown in the aforementioned embodiment, the present invention is not limited to this. In the present invention, the solder-ball-outer-peripheral-part image may be generated by a technique other than the technique taking the difference between the solder ball image and the post-exclusion solder ball image.

Also, while the example in which the post-exclusion solder ball image 140 in which the outer peripheral part 121a of the solder ball area 121 in the solder ball image 120 is excluded is generated by performing contraction processes that contract the solder ball area 121 by changing, into the non-solder-ball area 122, a target pixel in the outer peripheral part 121a of the solder ball area 121 in the solder ball image 120 if four neighboring pixels that are four pixels adjacent to the target pixel on the upward, downward, rightward and leftward sides include at least one pixel in the non-solder-ball area 122 has been shown in the aforementioned embodiment, the present invention is not limited to this. In the present invention, the post-exclusion solder ball image in which the outer peripheral part of the solder ball area in the solder ball image is excluded may be generated by performing contraction processes that contract the solder ball area by changing, into the non-solder-ball area, a target pixel in the outer peripheral part of the solder ball area in the solder ball image if eight neighboring pixels that are eight pixels adjacent to the target pixel include at least one pixel in the non-solder-ball area.

Also, while the example in which the post-exclusion solder ball image 140 in which the outer peripheral part 121a of the solder ball area 121 in the solder ball image 120 is excluded is generated by performing a number of the contraction processes, and the number of the contraction processes corresponds to a preset Manhattan distance has been shown in the aforementioned embodiment, the present invention is not limited to this. In the present invention, the post-exclusion solder ball image in which the outer peripheral part of the solder ball area in the solder ball image is excluded may be generated by performing a number of the contraction processes corresponding to a Manhattan distance that is newly set when generating the post-exclusion solder ball image.

Also, while the example in which the post-exclusion solder ball image 140 in which the outer peripheral part 121a of the solder ball area 121 in the solder ball image 120 is excluded is generated by performing a number of the contraction processes, which corresponds to the Manhattan distance, and the Manhattan distance is set to a value not greater than 3% of a diameter of the solder ball area 121 has been shown in the aforementioned embodiment, the present invention is not limited to this. In the present invention, the post-exclusion solder ball image in which the outer peripheral part of the solder ball area in the solder ball image is excluded may be generated by performing a number of the contraction processes corresponding to a Manhattan distance that is set to a value greater than 3% of the diameter of the solder ball area.

Also, while the example in which the void image 160 is generated to exclude, from the extraction image 130, the connection part 131b connected to the outer-periphery-correspondence part 131a in addition to the outer-periphery-correspondence part in the condition-satisfying area 131 has been shown in the aforementioned embodiment, the present invention is not limited to this. In the present invention, the post-exclusion image in which only the outer-periphery-correspondence part in the condition-satisfying area is excluded from the extraction image may be generated.

Also, while the example in which the void image 160 is generated to exclude, from the extraction image 130, a target pixel also as the connection part 131b in addition to the outer-periphery-correspondence part 131a in the condition-satisfying area 131 if eight neighboring pixels that are eight pixels adjacent to the target pixel include at least one pixel connecting the target pixel to the outer-periphery-correspondence part 131a has been shown in the aforementioned embodiment, the present invention is not limited to this. In the present invention, the void image may be generated to exclude, from the extraction image, a target pixel also as the connection part in addition to the outer-periphery-correspondence part in the condition-satisfying area if four neighboring pixels that are four pixels adjacent to the target pixel on the upward, downward, rightward and leftward sides include at least one pixel connecting the target pixel to the outer-periphery-correspondence part.

While the example in which the void inspection system 100 includes the solder ball inference apparatus 30 has been shown in the aforementioned embodiment, the present invention is not limited to this. In the present invention, the void inspection system may not include the solder ball inference apparatus. In this case, the void inspection system may be provided outside of the void inspection system, or the controller of the void inspection apparatus may be configured to serve also as the solder ball inference apparatus.

Also, while the example in which the void inspection system 100 inspects voids in the plurality of solder balls 91 having sizes similar to each other has been shown in the aforementioned embodiment, the present invention is not limited to this. In the present invention, the void inspection system may inspect voids in a plurality of solder balls having different sizes from each other.

Also, while the example in which the void inspection system 100 inspects voids in the plurality of solder balls 91 placed on the board 90 has been shown in the aforementioned embodiment, the present invention is not limited to this. In the present invention, the void inspection system may inspect voids in one solder ball placed on the board.

Also, while the example in which the controller 31 of the solder ball inference apparatus 30 generates the probability image (inference image) representing the probability of the part that is the solder ball area 121 in the X-ray image 110, which is input from the controller 21 of the void inspection apparatus 20, by using the learned model 32a stored in the storage 32 of the solder ball inference apparatus 30 has been shown in the aforementioned embodiment, the present invention is not limited to this. In the present invention, the controller of the void inspection apparatus may generate a probability image (inference image) representing a probability of a part of the X-ray image that is the solder ball area by using a learned model stored in a storage of the void inspection apparatus.

Also, while the example in which the extraction image 130 in which the condition-satisfying area 131, which is a part whose pixel values in a composite image of the X-ray image 110 and the solder ball image 120 satisfy a condition for extraction of the void area 161, is extracted, and the void image 160 is generated based on the solder ball image 120 and the extraction image 130 to exclude, from the extraction image 130, the outer-periphery-correspondence part 131a corresponding to the outer peripheral part 121a of the solder ball area 121 in the condition-satisfying area 131 has been shown in the aforementioned embodiment, the present invention is not limited to this. In the present invention, the void image in which a void area included in the solder ball area is extracted to avoid extraction of the outer peripheral part of the solder ball area as the void area irrespective of pixel values of the outer peripheral part of the solder ball area may be generated directly from the solder ball image without generating the extraction image.

### MODES

It is understood by those skilled in the art that the exemplary embodiments described above are specific examples of the following aspects.

### Mode Item 1

A void inspection method includes generating a solder ball image in which a solder ball area is extracted from an X-ray image of a board on which a solder ball is placed; and generating a void image in which a void area included in the solder ball area is extracted to avoid extraction of an outer peripheral part of the solder ball area as the void area irrespective of pixel values of the outer peripheral part of the solder ball area in the solder ball image.

### Mode Item 2

In the void inspection method according to mode item 1, generating an extraction image in which a condition-satisfying area is extracted, the condition-satisfying area being a part whose pixel values in a composite image of the X-ray image and the solder ball image satisfy a condition for extraction of the void area is further provided; and the void image is generated based on the solder ball image and the extraction image to exclude, from the extraction image, an outer-periphery-correspondence part corresponding to the outer peripheral part of the solder ball area in the condition-satisfying area in the generating the void image.

### Mode Item 3

In the void inspection method according to mode item 2, generating a solder-ball-outer-peripheral-part image in which only the outer peripheral part of the solder ball area in the solder ball image is extracted is further provided; and the void image is generated based on the solder-ball-outer-peripheral-part image and the extraction image to exclude, from the extraction image, the outer-periphery-correspondence part of the solder ball area in the condition-satisfying area in the generating the void image.

### Mode Item 4

In the void inspection method according to mode item 3, generating a post-exclusion solder ball image in which the outer peripheral part of the solder ball area in the solder ball image is excluded is further provided; and the solder-ball-outer-peripheral-part image is generated by taking difference between the solder ball image and the post-exclusion solder ball image in the generating the solder-ball-outer-peripheral-part image.

### Mode Item 5

In the void inspection method according to mode item 4, the post-exclusion solder ball image in which the outer peripheral part of the solder ball area in the solder ball image is excluded is generated by performing a contraction process(es) that contracts/contract the solder ball area by changing, into a non-solder-ball area, a target pixel in the outer peripheral part of the solder ball area in the solder ball image if four neighboring pixels that are four pixels adjacent to the target pixel on upward, downward, rightward and leftward sides include at least one pixel in the non-solder-ball area in the generating the post-exclusion solder ball image.

### Mode Item 6

In the void inspection method according to mode item 5, the post-exclusion solder ball image in which the outer peripheral part of the solder ball area in the solder ball image is excluded is generated by performing a number of the contraction processes in the generating the post-exclusion solder ball image, and the number of the contraction processes corresponds to a preset Manhattan distance.

### Mode Item 7

In the void inspection method according to mode item 6, the post-exclusion solder ball image in which the outer peripheral part of the solder ball area in the solder ball image is excluded is generated by performing the number of the contraction processes, which corresponds to the Manhattan distance, in the generating the post-exclusion solder ball image, and the Manhattan distance is set to a value not greater than 3% of a diameter of the solder ball area.

### Mode Item 8

In the void inspection method according to any of mode items 2 to 7, the void image is generated to exclude, from the extraction image, a connection part connected to the outer-periphery-correspondence part in addition to the outer-periphery-correspondence part in the condition-satisfying area in the generating the void image.

### Mode Item 9

In the void inspection method according to mode item 8, the void image is generated to exclude, from the extraction image, a target pixel also as the connection part in addition to the outer-periphery-correspondence part in the condition-satisfying area if eight neighboring pixels that are eight pixels adjacent to the target pixel include at least one pixel connecting the target pixel to the outer-periphery-correspondence part in the generating the void image.

### Mode Item 10

A storage stores a void inspection program that causes a computer to perform control to generate a solder ball image in which a solder ball area is extracted from an X-ray image of a board on which a solder ball is placed; and control to generate a void image in which a void area included in the solder ball area is extracted to avoid extraction of an outer peripheral part of the solder ball area as the void area irrespective of pixel values of the outer peripheral part of the solder ball area in the solder ball image.

### Mode Item 11

A void inspection system includes an X-ray imaging apparatus performing X-ray imaging of a board on which a solder ball is placed; and a void inspection apparatus performing control to generate an X-ray image of the board, which is subjected to the X-ray imaging, control to generate a solder ball image in which a solder ball area is extracted from the X-ray image, and control to generate a void image in which a void area included in the solder ball area is extracted to avoid extraction of an outer peripheral part of the solder ball area as the void area irrespective of pixel values of the outer peripheral part of the solder ball area in the solder ball image.

### Mode Item 12

In the void inspection system according to mode item 11, the void inspection apparatus further performs control to generate an extraction image in which a condition-satisfying area is extracted, and the condition-satisfying area is a part whose pixel values in a composite image of the X-ray image and the solder ball image satisfy a condition for extraction of the void area; and the void image is generated based on the solder ball image and the extraction image to exclude, from the extraction image, an outer-periphery-correspondence part corresponding to the outer peripheral part of the solder ball area in the condition-satisfying area in the control to generate the void image.

### Mode Item 13

In the void inspection system according to mode item 12, the void inspection apparatus further performs control to generate a solder-ball-outer-peripheral-part image in which only the outer peripheral part of the solder ball area in the solder ball image is extracted; and the void image is generated based on the solder-ball-outer-peripheral-part image and the extraction image to exclude, from the extraction image, the outer-periphery-correspondence part of the solder ball area in the condition-satisfying area in the control to generate the void image.

### Mode Item 14

In the void inspection system according to mode item 13, the void inspection apparatus further performs control to generate a post-exclusion solder ball image in which the outer peripheral part of the solder ball area in the solder ball image is excluded; and the solder-ball-outer-peripheral-part image is generated by taking difference between the solder ball image and the post-exclusion solder ball image in the control to generate the solder-ball-outer-peripheral-part image.

### Mode Item 15

In the void inspection system according to mode item 14, the post-exclusion solder ball image in which the outer peripheral part of the solder ball area in the solder ball image is excluded is generated by performing a contraction process(es) that contracts/contract the solder ball area by changing, into a non-solder-ball area, a target pixel in the outer peripheral part of the solder ball area in the solder ball image if four neighboring pixels that are four pixels adjacent to the target pixel on upward, downward, rightward and leftward sides include at least one pixel in the non-solder-ball area in the control to generate the post-exclusion solder ball image.

### Mode Item 16

In the void inspection system according to mode item 15, the post-exclusion solder ball image in which the outer peripheral part of the solder ball area in the solder ball image is excluded is generated by performing a number of the contraction processes in the control to generate the post-exclusion solder ball image, and the number of the contraction processes corresponds to a preset Manhattan distance.

### Mode Item 17

In the void inspection system according to mode item 16, the post-exclusion solder ball image in which the outer peripheral part of the solder ball area in the solder ball image is excluded is generated by performing the number of the contraction processes, which corresponds to the Manhattan distance, in the control to generate the post-exclusion solder ball image, and the Manhattan distance is set to a value not greater than 3% of a diameter of the solder ball area.

### Mode Item 18

In the void inspection system according to any of mode items 12 to 17, the void image is generated to exclude, from the extraction image, a connection part connected to the outer-periphery-correspondence part in addition to the outer-periphery-correspondence part in the condition-satisfying area in the control to generate the void image.

### Mode Item 19

In the void inspection method according to mode item 18, the void image is generated to exclude, from the extraction image, a target pixel also as the connection part in addition to the outer-periphery-correspondence part in the condition-satisfying area if eight neighboring pixels that are eight pixels adjacent to the target pixel include at least one pixel connecting the target pixel to the outer-periphery-correspondence part in the control to generate the void image.

What is claimed is:

1. A void inspection method comprising:
generating a solder ball image in which a solder ball area is extracted from an X-ray image of a board on which a solder ball is placed; and
generating a void image in which a void area included in the solder ball area is extracted to avoid extraction of an outer peripheral part of the solder ball area as the void area irrespective of pixel values of the outer peripheral part of the solder ball area in the solder ball image.

2. The void inspection method according to claim 1 further comprising
generating an extraction image in which a condition-satisfying area is extracted, the condition-satisfying area being a part whose pixel values in a composite image of the X-ray image and the solder ball image satisfy a condition for extraction of the void area, wherein
the void image is generated based on the solder ball image and the extraction image to exclude, from the extraction image, an outer-periphery-correspondence part corresponding to the outer peripheral part of the solder ball area in the condition-satisfying area in the generating the void image.

3. The void inspection method according to claim 2 further comprising
generating a solder-ball-outer-peripheral-part image in which only the outer peripheral part of the solder ball area in the solder ball image is extracted, wherein
the void image is generated based on the solder-ball-outer-peripheral-part image and the extraction image to exclude, from the extraction image, the outer-periphery-correspondence part of the solder ball area in the condition-satisfying area in the generating the void image.

4. The void inspection method according to claim 3 further comprising
generating a post-exclusion solder ball image in which the outer peripheral part of the solder ball area in the solder ball image is excluded, wherein
the solder-ball-outer-peripheral-part image is generated by taking difference between the solder ball image and the post-exclusion solder ball image in the generating the solder-ball-outer-peripheral-part image.

5. The void inspection method according to claim 4, wherein the post-exclusion solder ball image in which the outer peripheral part of the solder ball area in the solder ball image is excluded is generated by performing a contraction process(es) that contracts/contract the solder ball area by changing, into a non-solder-ball area, a target pixel in the outer peripheral part of the solder ball area in the solder ball image if four neighboring pixels that are four pixels adjacent to the target pixel on upward, downward, rightward and leftward sides include at least one pixel in the non-solder-ball area in the generating the post-exclusion solder ball image.

6. The void inspection method according to claim 5, wherein the post-exclusion solder ball image in which the outer peripheral part of the solder ball area in the solder ball image is excluded is generated by performing a number of the contraction processes in the generating the post-exclusion solder ball image, and the number of the contraction processes corresponds to a preset Manhattan distance.

7. The void inspection method according to claim 6, wherein the post-exclusion solder ball image in which the outer peripheral part of the solder ball area in the solder ball image is excluded is generated by performing the number of the contraction processes, which corresponds to the Manhattan distance, in the generating the post-exclusion solder ball image, and the Manhattan distance is set to a value not greater than 3% of a diameter of the solder ball area.

8. The void inspection method according to claim 2, wherein the void image is generated to exclude, from the extraction image, a connection part connected to the outer-periphery-correspondence part in addition to the outer-periphery-correspondence part in the condition-satisfying area in the generating the void image.

9. The void inspection method according to claim 8, wherein the void image is generated to exclude, from the extraction image, a target pixel also as the connection part in addition to the outer-periphery-correspondence part in the condition-satisfying area if eight neighboring pixels that are eight pixels adjacent to the target pixel include at least one pixel connecting the target pixel to the outer-periphery-correspondence part in the generating the void image.

10. A storage storing a void inspection program that causes a computer to perform
control to generate a solder ball image in which a solder ball area is extracted from an X-ray image of a board on which a solder ball is placed; and
control to generate a void image in which a void area included in the solder ball area is extracted to avoid extraction of an outer peripheral part of the solder ball area as the void area irrespective of pixel values of the outer peripheral part of the solder ball area in the solder ball image.

11. A void inspection system comprising:
an X-ray imaging apparatus performing X-ray imaging of a board on which a solder ball is placed; and
a void inspection apparatus performing control to generate an X-ray image of the board, which is subjected to the X-ray imaging, control to generate a solder ball image in which a solder ball area is extracted from the X-ray image, and control to generate a void image in which a void area included in the solder ball area is extracted to avoid extraction of an outer peripheral part of the solder ball area as the void area irrespective of pixel values of the outer peripheral part of the solder ball area in the solder ball image.

12. The void inspection system according to claim 11, wherein
the void inspection apparatus further performs control to generate an extraction image in which a condition-satisfying area is extracted, and the condition-satisfying area is a part whose pixel values in a composite image of the X-ray image and the solder ball image satisfy a condition for extraction of the void area; and
the void image is generated based on the solder ball image and the extraction image to exclude, from the extraction image, an outer-periphery-correspondence part corresponding to the outer peripheral part of the solder ball area in the condition-satisfying area in the control to generate the void image.

13. The void inspection system according to claim 12, wherein
the void inspection apparatus further performs control to generate a solder-ball-outer-peripheral-part image in which only the outer peripheral part of the solder ball area in the solder ball image is extracted; and
the void image is generated based on the solder-ball-outer-peripheral-part image and the extraction image to exclude, from the extraction image, the outer-periphery-correspondence part of the solder ball area in the condition-satisfying area in the control to generate the void image.

14. The void inspection system according to claim 13, wherein
the void inspection apparatus further performs control to generate a post-exclusion solder ball image in which the outer peripheral part of the solder ball area in the solder ball image is excluded; and
the solder-ball-outer-peripheral-part image is generated by taking difference between the solder ball image and the post-exclusion solder ball image in the control to generate the solder-ball-outer-peripheral-part image.

15. The void inspection system according to claim 14, wherein the post-exclusion solder ball image in which the outer peripheral part of the solder ball area in the solder ball image is excluded is generated by performing a contraction process(es) that contracts/contract the solder ball area by changing, into a non-solder-ball area, a target pixel in the outer peripheral part of the solder ball area in the solder ball image if four neighboring pixels that are four pixels adjacent to the target pixel on upward, downward, rightward and leftward sides include at least one pixel in the non-solder-ball area in the control to generate the post-exclusion solder ball image.

16. The void inspection system according to claim 15, wherein the post-exclusion solder ball image in which the outer peripheral part of the solder ball area in the solder ball image is excluded is generated by performing a number of the contraction processes in the control to generate the post-exclusion solder ball image, and the number of the contraction processes corresponds to a preset Manhattan distance.

17. The void inspection system according to claim 16, wherein the post-exclusion solder ball image in which the outer peripheral part of the solder ball area in the solder ball image is excluded is generated by performing the number of the contraction processes, which corresponds to the Manhattan distance, in the control to generate the post-exclusion solder ball image, and the Manhattan distance is set to a value not greater than 3% of a diameter of the solder ball area.

18. The void inspection system according to claim 12, wherein the void image is generated to exclude, from the extraction image, a connection part connected to the outer-periphery-correspondence part in addition to the outer-periphery-correspondence part in the condition-satisfying area in the control to generate the void image.

19. The void inspection method according to claim 18, wherein the void image is generated to exclude, from the extraction image, a target pixel also as the connection part in addition to the outer-periphery-correspondence part in the condition-satisfying area if eight neighboring pixels that are eight pixels adjacent to the target pixel include at least one pixel connecting the target pixel to the outer-periphery-correspondence part in the control to generate the void image.
